(19) United States
(12) Patent Application Publication
(10) Pub. No.: US 2006/0107784 A1
(43) Pub. Date: May 25, 2006

(54) Steering column module

(75) Inventors: William E. Bostic, St. Clair, MI (US); Alex Koenig, Brischbrunn (DE); Carl Peterson, Warren, MI (US)

Correspondence Address: FOLEY AND LARDNER LLP;SUITE 500, 3000 K STREET NW, WASHINGTON, DC, 20007, US

(73) Assignee: TAKATA-PETRI, INC.

(21) Appl. No.: 11/322,273

(22) Filed: Jan. 3, 2006

Related U.S. Application Data
(62) Division of application No. 10/737,466, filed on Dec. 16, 2003.

(51) Int. Cl. B62D 1/04

(52) U.S. Cl. 74/552

(57) ABSTRACT

A method for assembling a vehicle steering system includes providing a pre-assembled steering column module that includes a steering wheel, an airbag module coupled to the steering wheel, an electronic conduit, a clock spring in electronic communication with the steering wheel and the electronic conduit, and at least one steering column component in electronic communication with the electronic conduit. The method also includes providing a vehicle including vehicle system circuitry and a vehicle steering mechanism. The method further includes coupling the pre-assembled steering column module to the vehicle system circuitry and to the vehicle steering mechanism.

### CROSS-REFERENCE TO RELATED PATENT APPLICATIONS

This application is a Division of U.S. patent application Ser. No. 10/737,466, filed Dec. 15, 2003, which claims the benefit of U.S. Provisional Patent Application No. 60/433,247, filed Dec. 13, 2002, both of which are incorporated herein by reference in their entirety.

### TECHNICAL FIELD

The present invention relates generally to vehicle steering assemblies, and more particularly to a modular steering column that facilitates more efficient assembly of the column with an associated vehicle.

### BACKGROUND

An ongoing goal of automotive designers has been to optimize the assembly process by simplifying the same at the vehicle assembly plants. A trend has been to coordinate the manufacture of various subassemblies through one supervisory supplier.

With respect to steering column assemblies, known assembly processes bring in various components of the steering column for integration into a finished steering column at the vehicle assembly plant. This typically involves a relatively greater number of manufacturing steps that include electronically connecting each steering column component to the vehicle electronic circuitry. Accordingly, each component must be individually connected to the steering column or to various jacks below the dashboard, for example.

With regard to the mechanical connection of the steering column to the vehicle steering mechanism, the steering column must typically be connected to the vehicle steering mechanism in relatively complicated and time consuming steps. Simplification of the assembly of the steering column to reduce the time and complexity of connection to the vehicle at the vehicle assembly plant would therefore be an improvement in the art.

### SUMMARY

An exemplary embodiment relates to a method for assembling a vehicle steering system. The method includes providing a pre-assembled steering column module that includes a steering wheel, an airbag module coupled to the steering wheel, an electronic conduit, a clock spring in electronic communication with the steering wheel and the electronic conduit, and at least one steering column component in electronic communication with the electronic conduit. The method also includes providing a vehicle including vehicle system circuitry and a vehicle steering mechanism. The method further includes coupling the pre-assembled steering column module to the vehicle system circuitry and to the vehicle steering mechanism.

Another exemplary embodiment relates to a method for manufacturing a vehicle steering assembly. The method includes assembling a steering column assembly comprising an electronic conduit, a plurality of components electronically coupled to the electronic conduit, a steering wheel, and an airbag coupled to the steering wheel. The method also includes providing the steering column assembly to a vehicle manufacturer. The steering column assembly comprises a plug for electronically coupling the electronic conduit to a vehicle electrical system and a member for mechanically coupling the steering column assembly to a vehicle. The steering column assembly is configured for mechanical and electronic coupling to the vehicle without the need to individually connect each of the plurality of components to the vehicle electrical system.

Another exemplary embodiment relates to a method for assembling a vehicle steering system. The method includes providing a pre-assembled steering column module comprising an airbag, a steering wheel, an electronic conduit, a plurality of components electronically coupled to the electronic conduit, a plug for electronically coupling the electronic conduit to vehicle circuitry, and a member for mechanically coupling the pre-assembled steering column module to a vehicle. The electronic conduit is configured to allow electronic communication between the vehicle circuitry and the plurality of components. The pre-assembled steering column module is configured for substantially simultaneous electronic and mechanical connection to the vehicle.

### BRIEF DESCRIPTION OF THE DRAWINGS

FIG. 1 illustrates an exploded view of one embodiment of the present invention, particularly useful when combined with an upper tilt steering mechanism on the receiver mechanical hub.

FIG. 2 illustrates an exploded view of one embodiment of the present invention, particularly useful when combined with either a fixed or “low rake” receiver mechanical hub.

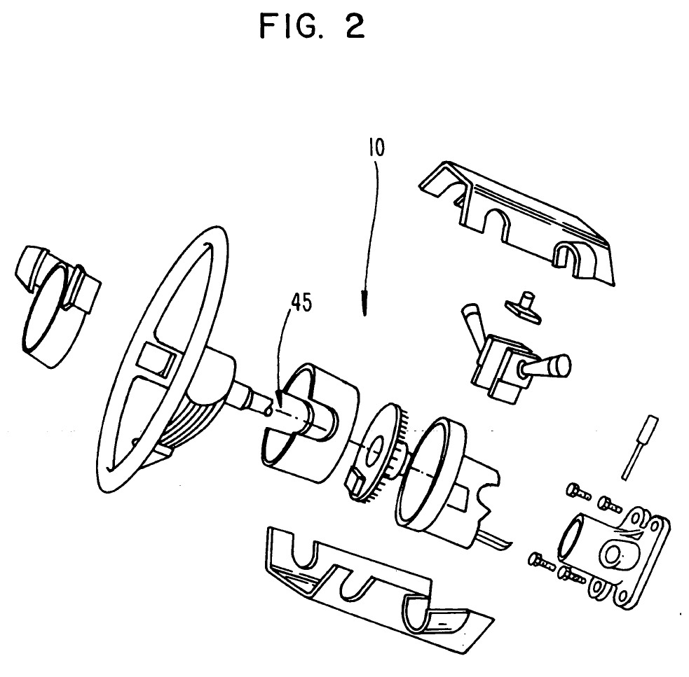

FIG. 3 is a perspective view of the electronic conduit, in accordance with the present invention.

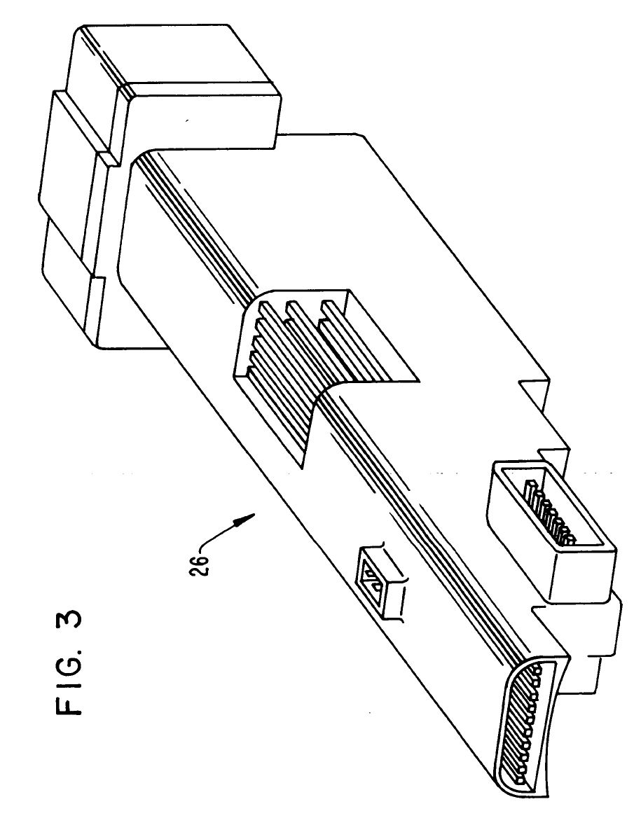

FIG. 4 is a perspective and partial sectional view of the electronic conduit, in accordance with the present invention.

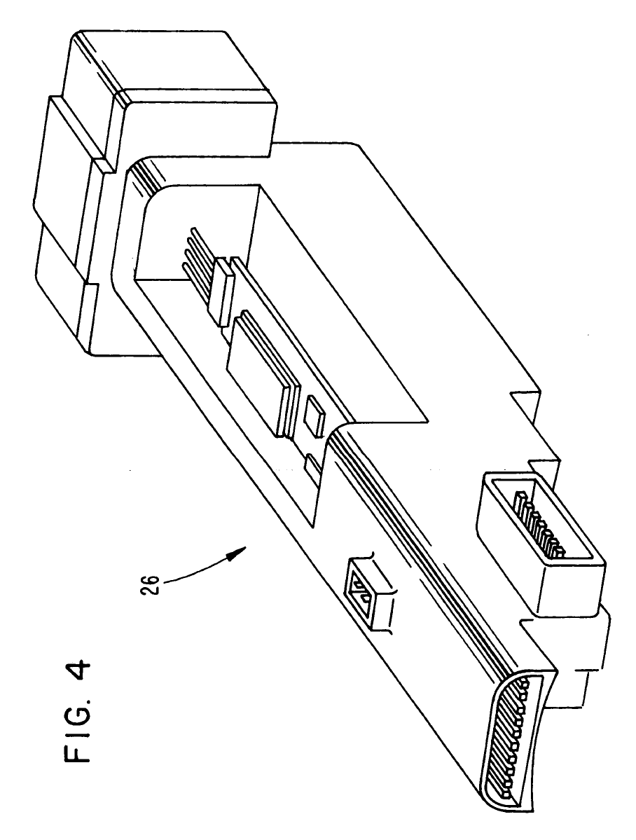

FIG. 5 is a perspective view of the interface between the steering column module and the vehicle steering mechanism and system electronics. As shown, a receiver or vehicle system plug is preferably fixed to the vehicle structure to mate with a corresponding conduit plug once the steering column is docked against the receiver.

### DETAILED DESCRIPTION

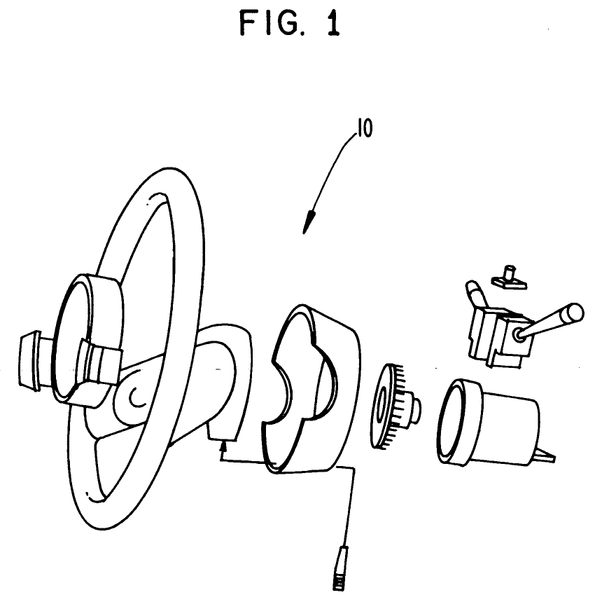

Referring to FIG. 1, there is shown an exploded view of a modular steering column assembly or module 10 in accordance with the present invention. The present steering column module 10 incorporates a modular plug-in characteristic for both electronic and mechanical communication between the steering column module 10 and the vehicle system circuitry 12 and the vehicle steering mechanism 14, respectively. As schematically shown in the figures, a receiver 16 is fixed to the vehicle cross-car beam preferably beneath the instrument panel 54, wherein the receiver 16 facilitates modular docking of the steering column module 10 and preferably slidably receives the steering column module 10.

In a first aspect of the invention, a first electronic connector 18 (e.g., a vehicle system jack or plug) preferably connected to an associated wire bundle or harness 20 of the vehicle circuitry 12 is housed within the receiver 16 and provides electronic communication between the vehicle circuitry 12 and the steering column circuitry 21. The vehicle circuitry 12 is designed in a known manner to preferably include a decoding function for the various switching that typically occurs along the steering column module 10. Naturally, the steering column circuitry 21 is also preferably designed to complement the decoding function of the vehicle circuitry 12. Therefore, an encoding module or circuitry is provided within the steering column circuitry 21 as known in the art whereby, for example, analog data is converted to digital data prior to transmittal of the data to the vehicle circuitry 12. An associated second electronic connector 22 is positioned along an end of the column module 10 such that upon docking the steering column module 10 within the receiver 16, the first and second electronic connectors 18 and 22 are mated to establish electronic communication between the vehicle and the steering column module 10. In accordance with the present invention, the second electronic connector 22 is positioned along a first end 24 of an electronic conduit 26 and integrates the various steering column components 28 or at least one steering column component 28 into at least one or more corresponding electronic conductors or connectors 32 preferably disposed along the length of the electronic conduit 26. Stated another way, each desired electronic component 28 of the steering column module 10 electronically communicates with a designated auxiliary electronic connector 32 along the electronic conduit 26. The various sub-modules or components 28 of the steering column module 10 may either electronically communicate directly with the electronic conduit 26 or may communicate remotely through intermediate circuitry.

For example, as shown in the figures, a clock spring 34 is preferably employed immediately aft of the steering wheel 36 and installed to the steering wheel 36 in a known manner. To illustrate, an exemplary clock spring 34 formed as described in U.S. Pat. No. 5,704,633, herein incorporated by reference, may be attached to the present steering column module 10 and steering wheel 36. Consistent therewith, the clock spring 34 may for example be integrated into a subassembly including the steering wheel 36, the airbag module 38, and the clock spring 34.

As shown in the figures, the steering wheel 36 contains an armature 40 and a frame 42. A first cylindrical extension 44 (e.g., a solid cylindrical bar or tube) having an outer or exvolute spline is diecast, welded, or otherwise fixed to the frame 42 and shares an axis 45 extending through the center of the frame 42. As such, the extension 44 when fixed to the frame 42 extends aft of the steering wheel 36 and away from the driver, thereby providing a mechanical coupling or communication between the steering wheel 36 and a mechanical hub or second cylindrical extension 46 of the receiver 16. Stated another way, the extension 44 is coaxially and slidably received within the mechanical hub 46 whereby the outer splines or flutes 48 of the extension 44 engage inner or involute splines of the hub 46 upon docking of the assembled steering column module 10. Alternatively, the extension 44 may instead be a tubular sleeve or female component having inner or involute splines or flutes 50. In that case, the mechanical hub 46 of the receiver 16 would correspondingly be a male rather than female component and as such, upon insertion of the column module 10 within the receiver 16, the inner splines of the extension 44 would therefore engage outer splines 48 preferably disposed about the hub circumference. Either way, it is believed that the joining of both the first and second cylindrical extensions 44 and 46, respectively, intermediate of the length of the steering column module 10 is particularly useful when mechanically docking the steering column module 10 consistent with the modular concept. The extension 44 also functions as a rack in that certain steering column components 28 are radially oriented about the extension 44 as they electronically communicate with the electronic conduit 26. Accordingly, the conduit 26 extends along substantially the length of the extension 44 for electronic interface of the components 28 radially oriented about the extension 44.

In a preferred embodiment, the annular clock spring 34 is radially disposed about the tube, immediately aft of the steering wheel 36 and toward the instrument panel 54. The clock spring 34 preferably snaps onto the rear of the steering wheel 36 or is otherwise fixed thereto. An airbag module 38 is fixed to the front of the steering wheel 36 opposite the clock spring 34, but electronically communicates with the clock spring 34 in a known manner. Stated another way, as described in U.S. Pat. No. 5,704,633 for example, the airbag module 38 when fixed to the clock spring 34 sandwiches the steering wheel 36 therebetween. In accordance with the present invention, electronic contacts of the electronic conduit 26 electronically communicate or are mated with corresponding electrical contacts on the clock spring 34. Therefore, a third plug or electronic connector 56 on the clock spring 34 mates and interfaces with a corresponding fourth plug or electronic connector 58 of the electronic conduit 26. In a preferred embodiment, the electronic conduit 26 is integrally molded into the clock spring 34 housing, thereby extending aft of the steering wheel 36 in the same direction as the tube. However, the clock spring 34 need not be molded to the electronic conduit 26, but instead may be attached to the electronic conduit 26 to form a subassembly.

Accordingly, upon a crash event and in a known manner, the clock spring 34 communicates a signal from a crash sensor (not shown) for example, thereby activating the airbag of the airbag module 38. A number of electrical connections extend from components on the steering wheel 36 and are connected to the clock spring 34 in a known manner. A rear steering wheel cover 60 preferably snaps over the clock spring 34. An opening in the rear cover 60 accepts passage of the electronic conduit 26 therethrough. If desired, the clock spring 34 may instead be installed aft of the rear cover 60 while still electronically communicating with components 28 on the steering wheel 36.

As shown in the figures, at least one and preferably a plurality of various auxiliary plugs, jacks, and/or electronic connectors 64 may be disposed along the length of the conduit 26 and facilitate attachment and electronic communication of other functional components 28. Or, the steering wheel 36 may comprise all of the functional switching desired for vehicle operation. As also shown in the figures, exemplary auxiliary electronic connectors 64 contain copper traces or frets 66, or pins or sockets 66, that basically extend radially outward thereby facilitating flush communication with a corresponding electronic connector of a respective component 28. At least one docking site 68, and more preferably a plurality of docking sites 68, each docking site 68 preferably corresponding to a respective functional component 28, facilitates flush communication between the component 28 and its respective auxiliary electronic connector 64. Accordingly, the docking site 68 might contain a pair of substantially parallel recessed grooves essentially transverse or parallel to the longitudinal axis 45 of the electronic conduit 26, that would be mated with a pair of correspondingly oriented extensions on a respective component 28, thereby facilitating slidable engagement of the component against the electronic conduit 26 and mating of opposing frets 66, for example. Or, the docking site 68 might instead include a plug or a jack 70 surrounded by a peripheral jacket 72 that provides juncture rigidity as a corresponding plug or jack 74 from an associated component is connected thereto.

As shown in U.S. Pat. No. 6,225,582, herein incorporated by reference, a centrally arranged support board could be integrated into the electronic conduit 26 for easy removal and replacement of steering column switches, for example. Associated circuitry as described therein could be employed as described. Or, as described in U.S. Pat. No. 6,417,468, herein incorporated by reference, electrical plugs integrated into steering column switches may be employed to connect the switches to the electronic conduit 26. Exemplary turn signal and hazard warning control apparatuses could be designed as described in U.S. Pat. No. 4,016,380, herein incorporated by reference. In essence, any component 28 useful in the steering column module 10 could be connected as described above. Other known or suitable electronic connectors 64 may also be utilized.

The various components 28 of the steering column module 10 are made by methods known in the art. The steering wheel 36 may, for example, have an armature 40 and frame 42 that is die cast, and then coated with a resilient coating by application of known foam mold processes. The first cylindrical extension 44 may, if desired, be die cast integral to the steering wheel 36 thereby obviating the need to separately fix the extension 44 to the steering wheel 36 after formation thereof. The various electronic components 28 may be supplied by manufacturers known in the art. For example, Valeo Schalter and Sensoren GmbH of Germany and/or Yazaki Corporation of Japan may provide various steering column components 28 as described in U.S. Pat. Nos. 6,183,005 and 6,417,468, herein incorporated by reference. Alternatively, electronic connectors may be manufactured as described in U.S. Pat. Nos. 6,132,229, 6,116,919, 3,993,936, 6,475,005, and 6,386,909, herein incorporated by reference, and then integrated with known components 28. The electronic conduit 26 may be molded from rigid polymers and simultaneously inlayed with copper metal traces 66 and/or copper or metallic tubes 66 coextensive with the electronic conduit 26. In other words, the various connectors 64 may be made from known methods. It is contemplated that the mechanical hub or second cylindrical extension 46, and a rocker (described below) may be die cast or otherwise formed and then integrated into the vehicle structure 78 (e.g., a cross car beam) with the cooperation of the original equipment manufacturer and/or manufacturers of the vehicle steering mechanism 14 such as Eaton. In the same way, the system circuitry 12 supplied on the first electronic connector 18 at the mechanical hub 46 may also be provided with the cooperation of the original equipment manufacturer, for example.

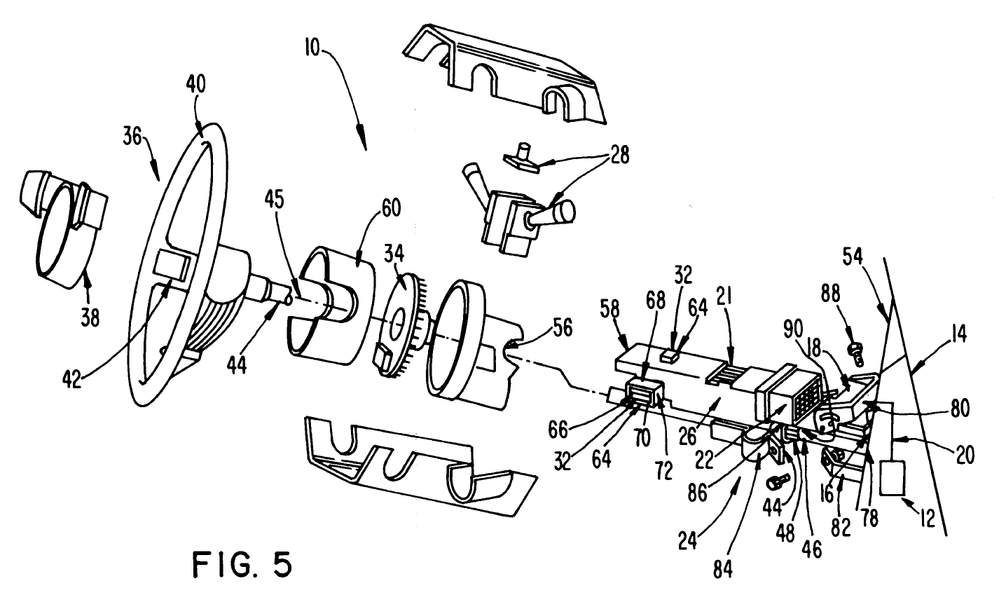

FIG. 5 is a perspective view of the interface between the steering column module 10 and the receiver 16. As shown, the first electronic connector 18 is fixed to the vehicle structure 78 to mate with the second electronic connector or electronic conduit plug 22 once the steering column module 10 is docked against the receiver 16. A cam lock 80 is pivotally rotatable about the first electronic connector 18 and assists in firmly seating the conduit plug 22 against the first electronic connector 18. The communication between the mechanical hub or second cylindrical extension 46, and the column rack or first cylindrical extension 44 is further illustrated. As also shown in the figures, the steering column module 10 may be firmly fixed to the receiver 16 simply by bolting or fixing at least one receiver bracket 82 to at least one steering column bracket 84.

It should be emphasized that in accordance with the present invention, connecting all of the steering column circuitry 21 to one conduit 26 facilitates simultaneous electronic and mechanical docking of the steering column module 10: mechanical docking by mating the extension 44 and the mechanical hub 46, and, electronic docking by mating the first and second electronic connectors 18 and 22 of the receiver 16 and the conduit 26, respectively. Unlike the related art, integrating the extension 44 centrally of the steering wheel 36 and integrating the electronic circuitry into one electronic conduit 26 rather than a plurality of plugs as is conventionally practiced, enables one-step docking at the assembly point. In essence, the various steering column component circuitries are consolidated into one electronic conduit 26 communicating with one receiver plug (e.g., first electronic connector 18), rather than many. The present invention therefore facilitates complete assembly of the entire steering column module 10 prior to modular installation at the assembly plant. As such, simple insertion and fastening of the steering column module 10 into the receiver accomplishes simplified electronic and mechanical docking at the assembly plant.

It should be further emphasized that the second electronic connector 22 is fixed at a point relative to the first end 86 of the first cylindrical extension 44, thereby ensuring consistent mechanical and electronic alignment during coupling of the column module 10 with the vehicle. Bolts 88 exemplify fasteners that may be employed to secure the column module 10 to the receiver and/or instrument panel 54.

Finally, the extension 44 may be designed to accommodate tilt steering. As described in U.S. Pat. No. 5,606,892, herein incorporated by reference, when tilt steering is desired, the mechanical hub 46 of the receiver 16 may also include either a “low rake” or low pivot point recessed within the instrument panel 54. Or, it may include an upper tilt steering mechanism integral to the mechanical hub 46 at a point where the mechanical hub 46 connects with the extension 44. An exemplary tilt steering mechanism is described in U.S. Pat. No. 6,450,058, herein incorporated by reference. In one low rake embodiment, the first electronic connector 18 shown in FIG. 5 would preferably be fixed at a point between the pivot point on the mechanical hub 46 and the steering wheel 36. The flexible wire harness 20 connected to the first electronic connector 18 would accommodate any change in the tilt or pivoting action of the mechanical hub 46. In the same way, the tilt steering mechanism could also be fitted with a first electronic connector 18 connected to a flexible wire harness 20 thereby facilitating tilt steering and yet adhering to the modular concept. One of ordinary skill in the art will appreciate that other known designs may be utilized to the extent they do not compromise the modular concepts described herein.

Alternatively, the first electronic connector 18 connected to a flexible wire harness 20 could be fixed to the cross-car beam 78 on a pivoting rocker or seat thereby orienting the angle of the first electronic connector 18 to the angle of the steering column module 10 once tilted. In the same way, the mechanical hub or second cylindrical extension 46 could be coupled to the vehicle steering mechanism 14 in a known way, but still fixed to the rocker to ensure consistent mechanical and electrical alignment.

In accordance with the exemplary embodiments described herein, a steering column is designed to provide a modular quick-connect to a vehicle electronic system and a vehicle steering mechanism. A steering wheel is connected to a clock spring in a known manner thereby providing electronic communication with the steering wheel. The clock spring includes a first electronic connector for communication with the vehicle electronic system. An electronic conduit extends along the length of the steering column and is preferably constructed of a rigid material. The electronic conduit includes a first end and a second end for providing electronic communication from the clock spring to the vehicle electronic system at an end of the steering column opposite the steering wheel. A first electronic connector at the first end of the electronic conduit connects the electronic conduit to the vehicle electronic system. A second electronic connector at the second end of the electronic conduit connects the clock spring with the electronic conduit to provide electronic communication between the steering wheel, the clock spring, and the vehicle electronic circuitry.

At least one auxiliary electronic connector is preferably formed on the electronic conduit for electronic connection with at least one steering column component such as a turn signal module. A docking site is formed about the auxiliary electronic connector and thereby provides a seat for flush communication between the electronic conduit and the steering wheel component. A plurality of docking sites formed about a plurality of electronic connectors, for flush communication with a plurality of respective components, is also contemplated. Docking the component against the electronic conduit establishes electronic communication between the component and the vehicle electronic system.

The steering column may further include a rocker mounted proximate the vehicle steering mechanism, whereby a system electronic jack of the vehicle electronic circuitry is fixed on the rocker to facilitate electronic communication of the steering column while adjusting the tilt of the steering column.

A first cylindrical extension extends from the steering wheel and connects the steering wheel to the vehicle steering mechanism. The first cylindrical extension contains a first end configured as a male or female fitting. A second cylindrical extension extends from the steering mechanism or receiver hub for connection with the first cylindrical extension, whereby the second cylindrical extension includes a second end formed as a male or female fitting, opposite and complementary to the fitting of the first end of the first cylindrical extension.

By mating the first end with the second end, the first and second extensions are mechanically coupled in a lock and key configuration. The electronic conduit is fixed to the first cylindrical extension whereby the first electronic connector is longitudinally oriented along the first cylindrical extension to provide simultaneous electronic and mechanical connection as the first cylindrical extension is mated with the second cylindrical extension. Modular assembly of the steering column within the vehicle is facilitated as the steering column is juxtaposed against the system jack and the vehicle steering mechanism.

The present description is for illustrative purposes only, and should not be construed to limit the present invention in any way. Thus, those skilled in the art will appreciate that various modifications might be made to the presently disclosed embodiments without departing from the scope of the invention as described above and as stated in the appended claims.

What is claimed is:

1. A method for assembling a vehicle steering system comprising:
providing a pre-assembled steering column module comprising a steering wheel, an airbag module coupled to the steering wheel, an electronic conduit, a clock spring in electronic communication with the steering wheel and the electronic conduit, and at least one steering column component in electronic communication with the electronic conduit;
providing a vehicle comprising vehicle system circuitry and a vehicle steering mechanism; and
coupling the pre-assembled steering column module to the vehicle system circuitry and to the vehicle steering mechanism.

2. The method of claim 1, wherein the step of coupling the pre-assembled steering column module to vehicle system circuitry and a vehicle steering mechanism comprises simultaneously coupling the steering column module to the vehicle system circuitry and the vehicle steering mechanism.

3. The method of claim 1, wherein the at least one steering column component comprises a turn signal module and further comprising coupling the turn signal module to the electronic conduit.

4. The method of claim 1, wherein the pre-assembled steering column module comprises a plug for coupling the electronic conduit to the vehicle system circuitry.

5. The method of claim 4, wherein the vehicle comprises a receiver jack and the step of coupling the pre-assembled steering column module to the vehicle system circuitry comprises coupling the plug to the receiver jack.

6. The method of claim 1, wherein the electronic conduit comprises a plurality of connectors for facilitating attachment of components of the steering column module to the electronic conduit.

7. The method of claim 6, wherein at least one of the plurality of connectors comprises a docking site for a plug from a component of the steering column module.

8. The method of claim 1, wherein the pre-assembled steering column module comprises a cylindrical extension and the step of coupling the pre-assembled steering column module to the vehicle steering mechanism comprises coupling the cylindrical extension to the vehicle steering mechanism.

9. The method of claim 1, further comprising assembling the pre-assembled steering column module.

10. The method of claim 9, wherein the step of providing the pre-assembled steering column module comprises electrically coupling a plurality of components to the electronic conduit.

11. A method for manufacturing a vehicle steering assembly comprising:
assembling a steering column assembly comprising an electronic conduit, a plurality of components electronically coupled to the electronic conduit, a steering wheel, and an airbag coupled to the steering wheel; and
providing the steering column assembly to a vehicle manufacturer;
wherein the steering column assembly comprises a plug for electronically coupling the electronic conduit to a vehicle electrical system and a member for mechanically coupling the steering column assembly to a vehicle;
whereby the steering column assembly is configured for mechanical and electronic coupling to the vehicle without the need to individually connect each of the plurality of components to the vehicle electrical system.

12. The method of claim 11, wherein the member for mechanically coupling the steering column assembly to a vehicle comprises a cylindrical extension.

13. The method of claim 12, wherein the vehicle comprises a vehicle steering system comprising a mechanical hub and further comprising coupling the cylindrical extension to the mechanical hub.

14. The method of claim 11, wherein the plurality of components comprise a turn signal module and a clock spring and the step of assembling the steering column assembly comprises coupling the turn signal module and the clock spring to the electronic conduit.

15. The method of claim 11, wherein the vehicle comprises a receiver jack and further comprising coupling the plug to the receiver jack.

16. The method of claim 11, wherein the electronic conduit comprises a plurality of connectors for facilitating attachment of the plurality of components to the electronic conduit.

17. The method of claim 16, wherein at least one of the plurality of connectors comprises a docking site for a plug from one of the plurality of components.

18. The method of claim 11, wherein the step of assembling the steering column assembly comprises electrically coupling the plurality of components to the electronic conduit.

19. A method for assembling a vehicle steering system, comprising:
providing a pre-assembled steering column module comprising an airbag, a steering wheel, an electronic conduit, a plurality of components electronically coupled to the electronic conduit, a plug for electronically coupling the electronic conduit to vehicle circuitry, and a member for mechanically coupling the pre-assembled steering column module to a vehicle;
wherein the electronic conduit is configured to allow electronic communication between the vehicle circuitry and the plurality of components; and
wherein the pre-assembled steering column module is configured for substantially simultaneous electronic and mechanical connection to the vehicle.

20. The method of claim 11, further comprising mechanically and electrically coupling the pre-assembled steering column module to a vehicle.

21. The method of claim 11, wherein the plurality of components comprise a clock spring and further comprising coupling the clock spring to the electronic conduit.

22. The method of claim 11, wherein the plurality of components comprise a steering column component and further comprising coupling the steering column component to the electronic conduit.

23. The method of claim 22, wherein the steering column component comprises a turn signal module.

24. The method of claim 11, wherein the electronic conduit comprises a plurality of connectors for facilitating attachment of the plurality of components.

25. The method of claim 11, wherein the member for mechanically coupling the pre-assembled steering column module to a vehicle comprises a cylindrical extension for mechanically coupling the pre-assembled steering column module to a vehicle steering mechanism.

26. The method of claim 11, further comprising electronically coupling the plurality of components to the electronic conduit.
